(19) United States
(12) Patent Application Publication
(10) Pub. No.: US 2008/0219482 A1
(43) Pub. Date: Sep. 11, 2008

(54) Condenser microphone

(75) Inventor: Akiyoshi Sato, Hamamatsu-Shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 11/980,028

(22) Filed: Oct. 30, 2007

(30) Foreign Application Priority Data
Oct. 31, 2006 (JP) 2006-295057

(51) Int. Cl. H04R 25/00

(52) U.S. Cl. 381/174

(57) ABSTRACT

An electroacoustic transducer includes a condenser microphone, which includes a package having a cavity and a through-hole, a plate whose thickness is thinner than the length of the through-hole and which has a sound hole overlapping with the through-hole in plan view, and an electroacoustic transducer die, which is stored in the cavity of the package. The electroacoustic transducer die includes a fixed electrode and a diaphragm electrode, which are positioned opposite to each other and which are supported by and enclosed inside of a support. The sound hole of the plate is reduced in dimensions realizing a small sectional area and a small depth, thus realizing a high resonance frequency higher than the audio frequency range.

### BACKGROUND OF THE INVENTION

1. Field of the Invention

The present invention relates to electroacoustic transducers including condenser microphones and in particular to condenser microphones encapsulated in packages suited to MEMS (Micro-Electro-Mechanical Systems).

This application claims priority on Japanese Patent Application No. 2006-295057, the content of which is incorporated herein by reference.

2. Description of the Related Art

Conventionally-known condenser microphones are encapsulated in MEMS sensor packages. U.S. Patent Application Publication No. US 2005/0185812 A1 teaches a miniature silicon condenser microphone, in which an electroacoustic transducer die joining a wiring substrate is enclosed in a package having a cover and in which a sound hole allowing sound waves to reach the electroacoustic transducer die is formed in the cover of the package or the wiring substrate. There is a possibility in that dust, light, and liquid drops may enter into the sound hole so as to badly affect the operation of the electroacoustic transducer die within the package. For this reason, it is preferable that the diameter of the sound hole be reduced as small as possible.

However, resonance may occur in low frequencies as the sound hole is reduced in diameter and is increased in depth. When the sound hole is formed in the wiring substrate, which corresponds to the bottom of the package, or the cover of the package, the depth of the sound hole substantially matches the thickness of the wiring substrate or the thickness of the cover. This unexpectedly causes resonance in the audio frequency range.

### SUMMARY OF THE INVENTION

It is an object of the present invention to provide an electroacoustic transducer including a MEMS condenser microphone whose sound hole has a high resonance frequency.

In a first aspect of the present invention, a condenser microphone includes a package having a cavity and a through-hole, and a plate, which joins the package and which has a sound hole communicated with the through-hole, in which the plate is thinner than the length of the through-hole, and in which the sound hole overlaps the through-hole in plan view, and an electroacoustic transducer die, which is stored in the cavity of the package. Compared with the conventionally-known technology in which the sound hole is formed in the package, the condenser microphone of the present invention is designed to reduce the depth of the sound hole, thus increasing the resonance frequency of the sound hole.

In the above, the package further includes a bottom portion, and a cover. The bottom portion having the through-hole joins an external wiring substrate. The cover joins the bottom portion so as to form the cavity together with the bottom portion, wherein the plate joining the bottom portion is thinner than the length of the through-hole. In addition, the electroacoustic transducer die further includes a fixed electrode and a diaphragm electrode, which are positioned opposite to each other, as well as a support. The support supports and encloses the fixed electrode and the diaphragm electrode, and the support joins the bottom portion or the plate in the surrounding area of the sound hole. Due to the aforementioned structure, the sound hole overlaps with the electroacoustic transducer die in plan view; hence, it is possible to reduce the size of a footprint of the condenser microphone. In addition, sound waves directly reach the electroacoustic transducer die from the bottom portion of the package, whereby the external space having a relatively large volume, which lies externally of the electroacoustic transducer die within the package, can be used as the back cavity; hence, it is possible to reduce the cutoff frequency.

Specifically, it is preferable that the depth of the sound hole be set to 100 μm or less, and the diameter of the sound hole be set to 100 μm or less. The depth of the sound hole substantially matches the thickness of the plate. It is preferable that the plate be composed of a metal material. Incidentally, the plate can be designed in the form of a lead frame. In the case of the package using the lead frame, the sound hole can be formed in the lead frame. This makes it possible to simplify the overall structure of the condenser microphone and to reduce the manufacturing cost.

The condenser microphone can be designed in such a way that the bottom portion forms a multilayered wiring substrate, and the plate is formed using a conductive film joining the surface of the multilayered wiring substrate. This further reduces the manufacturing cost because the plate can join the multilayered wiring substrate during its manufacturing process. Alternatively, the condenser microphone is designed such that the bottom portion forms a multilayered wiring substrate, and the plate is formed using a conductive film embedded in the multilayered wiring substrate. This further reduces the manufacturing cost as well.

The condenser microphone can be redesigned to include a package having a cavity and a through-hole, a first plate and a second plate, which join the package, wherein a first sound hole of the first plate and a second sound hole of the second plate communicate with the though-hole and overlap with the through-hole in plan view, and an electroacoustic transducer die, which is stored in the cavity of the package. The package further includes a bottom portion having the through-hole, which joins an external wiring substrate, and a cover, which joins the bottom portion so as to form the cavity together with the bottom portion. Each of the first plate and the second plate joining the bottom portion is smaller than the bottom portion in thickness. The electroacoustic transducer die further includes a fixed electrode and a diaphragm electrode, which are positioned opposite to each other, as well as a support for supporting and enclosing the fixed electrode and the diaphragm electrode. The support joins the bottom portion or the plate in the surrounding area of the sound hole. The first plate and the second plate, which join the bottom portion forming a multilayered wiring substrate, overlap with each other in plan view via an insulating layer therebetween. The aforementioned structure is advantageous in that the manufacturing cost can be reduced since the plate can join the multilayered wiring substrate during its manufacturing process.

It is preferable that the first sound hole of the first plate does not overlap with the second sound hole of the second plate in plan view since dust, light, and liquid drops cannot directly enter into the package even when they pass through both of the first hole of the first plate and the second hole of the second plate. This improves the environmental adaptability of the condenser microphone.

It is possible to further include a porous sheet, which is inserted between the first plate and the second plate. The porous sheet further improves the environmental adaptability of the condenser microphone. In addition, it is possible to further include a water-repellant film, which is formed in the surrounding area of the sound hole in the backside of the plate positioned in proximity to the electroacoustic transducer die. This improves the drip-proof ability of the condenser microphone.

The periphery of the plate includes a projection area of the electroacoustic transducer die. Generally speaking, the electroacoustic transducer die of the condenser microphone has a relatively high output impedance, whereby the plate functions as a noise shield of the electroacoustic transducer die; hence, it is possible to improve the S/N ratio of the condenser microphone.

When the plate is set to the ground potential, it is possible to further improve the noise shield effect of the plate; hence, it possible to further improve the S/N ratio of the condenser microphone.

In a second aspect of the present invention, an electroacoustic transducer includes a condenser microphone, and an external wiring substrate which the condenser microphone joins. The condenser microphone further includes a bottom portion having a through-hole, which joins the external wiring substrate, a cover, which joins the bottom portion so as to form a cavity together with the bottom portion, a plate, which joins the bottom portion and which is thinner than the length of the through-hole, wherein the plate has a sound hole overlapping with the through-hole in plan view, and an electroacoustic transducer die, which further includes a fixed electrode and a diaphragm electrode, which are positioned opposite to each other, as well as a support for supporting and enclosing the fixed electrode and the diaphragm electrode, wherein the external wiring substrate has a second through-hole that overlaps with the through-hole of the bottom portion. Compared with the technology in which the sound hole is formed in the bottom portion of the package joining the external wiring substrate, it is possible to reduce the depth of the sound hole since the sound hole is formed in the plate whose thickness is smaller than the thickness of the bottom portion joining the external wiring substrate. This makes it possible to increase the resonance frequency of the sound hole.

In the above, the support joins the bottom portion or the plate in relation to the surrounding area of the sound hole of the plate. Since the sound hole overlaps with the electroacoustic transducer die in plan view, it is possible to reduce the size of a footprint of the condenser microphone; thus, it is possible to reduce the overall size of the electroacoustic transducer. Sound waves directly reach the electroacoustic transducer die from the bottom portion joining the external wiring substrate, whereby the external space having a relatively large volume, which lies externally of the electroacoustic transducer die within the package, can be used as a back cavity; thus, it is possible to reduce the cutoff frequency.

### BRIEF DESCRIPTION OF THE DRAWINGS

These and other objects, aspects, and embodiments of the present invention will be described in more detail with reference to the following drawings, in which:

FIG. 1A is a longitudinal sectional view showing the constitution of an electroacoustic transducer including a condenser microphone in accordance with a preferred embodiment of the present invention;

FIG. 1B is a plan view of a package enclosing the electroacoustic transducer shown in FIG. 1A;

FIG. 2A is a longitudinal sectional view showing the constitution of an electroacoustic transducer including a condenser microphone in accordance with a first variation;

FIG. 2B shows enlarged views regarding a section B shown in FIG. 2A;

FIG. 3A is a longitudinal sectional view showing the constitution of an electroacoustic transducer including a condenser microphone in accordance with a second variation;

FIG. 3B is a plan view showing a package enclosing the electroacoustic transducer shown in FIG. 3A;

FIG. 4A is a longitudinal sectional view showing the constitution of an electroacoustic transducer including a condenser microphone in accordance with a third variation;

FIG. 4B is a plan view showing a package enclosing the electroacoustic transducer shown in FIG. 4A;

FIG. 5 is a longitudinal sectional view showing the constitution of an electroacoustic transducer including a condenser microphone in accordance with a fourth variation;

FIG. 6A is a longitudinal sectional view diagrammatically showing an example of the laminated structure of an electroacoustic transducer die included in the condenser microphone;

FIG. 6B is a longitudinal sectional view diagrammatically showing the relationship between constituent elements of the electroacoustic transducer die; and

FIG. 7 is a longitudinal sectional view showing the constitution of a condenser microphone including the electroacoustic transducer die shown in FIGS. 6A and 6B.

### DESCRIPTION OF THE PREFERRED EMBODIMENT

The present invention will be described in further detail by way of examples with reference to the accompanying drawings.

### A. Preferred Embodiment

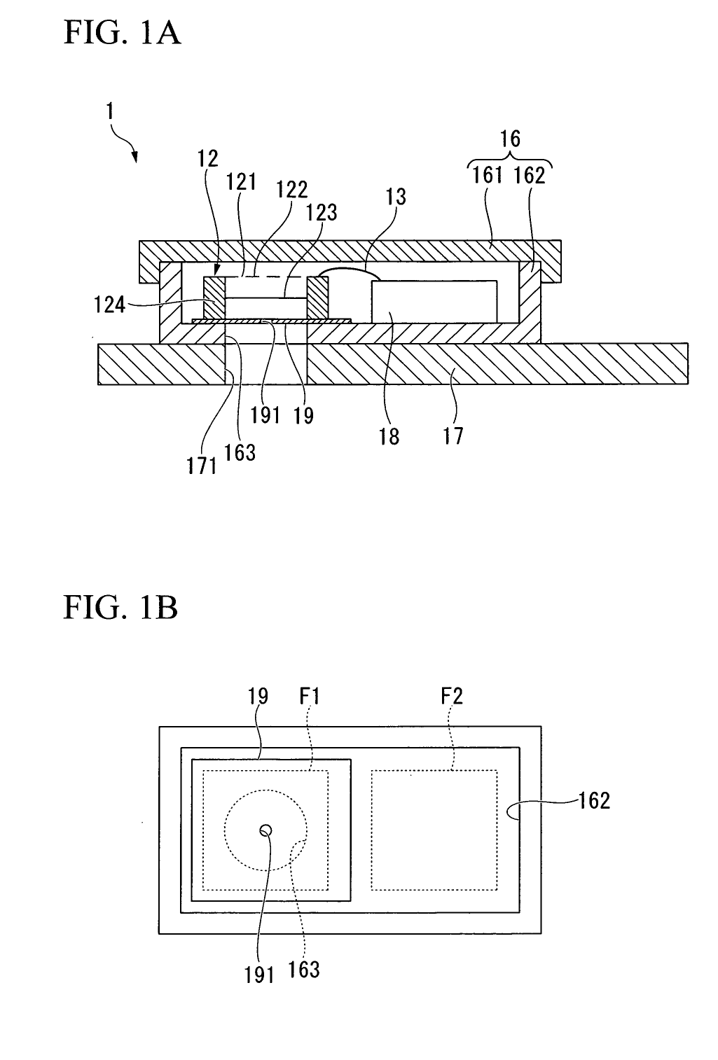

FIG. 1A is a longitudinal sectional view showing the essential parts of an electroacoustic transducer in accordance with a preferred embodiment of the present invention. The electroacoustic transducer including a condenser microphone 1 can be installed in various electronic devices such as portable telephone terminals, voice recorders, and notebook computers, in which it converts sounds into electric signals. A housing (or a casing) forming the exterior of the electroacoustic transducer incorporates an external wiring substrate 17 for mounting various electronic parts and components thereon. The condenser microphone 1 joins the external wiring substrate 17 via a ball grid array (BGA, not shown). A second through-hole 171 is formed to run through the external wiring substrate 17 at a prescribed position just below the condenser microphone 1. The second through-hole 171 allows sound waves to be transmitted to the condenser microphone 1. In addition, a through-hole allowing sound waves to be transmitted to the second through-hole 171 is formed in the housing forming the exterior of the electroacoustic transducer.

### (1) Constitution of Condenser Microphone

The condenser microphone 1 is constituted of an electroacoustic transducer die 12, an impedance converter die 18, and a package 16 enclosing them as well as a plate 19 joining the package 16. The electroacoustic transducer die 12 and the impedance converter die 18 are electrically connected together by way of wire bonding using metal wires 13. The impedance converter die 18 is electrically connected to the wiring of the package 16 by way of wire bonding or flip-chip bonding.

### (2) Electroacoustic Transducer Die

The electroacoustic transducer die 12 converts sound waves into electric signals. The electroacoustic transducer die 12 has a structure in which a conductive film such as a silicon-doped thin film and an insulating film such as a silicon oxide film are laminated onto a silicon wafer (not shown). The electroacoustic transducer die 12 includes electrode membranes, which serve as a diaphragm electrode 123 (forming an opposite electrode of a condenser) and a fixed electrode 122 (positioned opposite to the diaphragm electrode 123), and a support 124, which is shaped to support and surround the electrode membranes. The support 124 joins the surrounding area of a sound hole 191 of the plate 19.

The diaphragm electrode 123 forms a diaphragm realizing partitioning between two spaces. One space within the two spaces partitioned by the diaphragm electrode 123 is referred to as an acoustic space into which sound waves subjected to conversion by the electroacoustic transducer die 12 enter, and the other space is referred to as a back cavity. A plurality of back through-holes 121 are formed in the fixed electrode 122 positioned inside of the back cavity; hence, the back cavity partitioned by the electroacoustic transducer die 123 includes an external space of the electroacoustic transducer die 12 inside of the package 16. FIG. 1A shows an example of the condenser microphone 1 in which the fixed electrode 122 is positioned in the back cavity; instead, the fixed electrode 122 can be positioned in the acoustic space, wherein sound waves transmitted through through-holes of the fixed electrode 122 reach the diaphragm electrode 123.

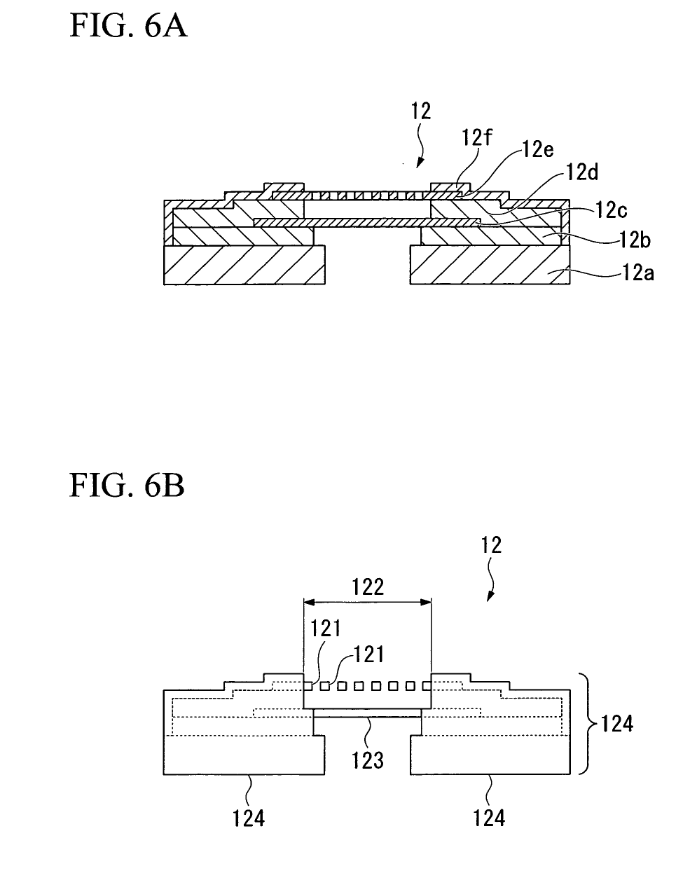

FIG. 6A is a longitudinal sectional view diagrammatically showing an example of the laminated structure of the electroacoustic transducer die 12. The electroacoustic transducer die 12 has the laminated structure including a substrate 12a, a lower insulating film 12b, a lower conductive film 12c, a spacer insulating film 12d, an upper conductive film 12e, and a surface insulating film 12f. The aforementioned substrate 12a and the thin films 12b to 12f mutually join together in the electroacoustic transducer die 12. The electroacoustic transducer die 12 is formed in such a way that the lower conductive film 12c, the upper conductive film 12e, the lower conductive film 12c, the spacer insulating film 12d, the upper conductive film 12e, and the surface insulating film 12f are sequentially formed on the substrate 12a, i.e., a silicon substrate, by way of deposition; these thin films are subjected to patterning; then, they are subjected to dicing.

FIG. 6B is a longitudinal sectional view diagrammatically showing the relationship between the substrate 12a, the thin films 12b to 12f, and the mechanical parts of the electroacoustic transducer die 12, wherein dotted lines show boundaries between the substrate 12a and the thin films 12b to 12f in the electroacoustic transducer die 12. The fixed electrode 122 is formed using the upper conductive film 12e composed of a silicon-doped thin film. It is possible to form the peripheral shape of the fixed electrode 122 in a circular shape, a rectangular shape, or a polygonal shape. The diaphragm electrode 123 is formed using the lower conductive film 12c composed of a silicon-doped thin film. It is possible to form the peripheral shape of the diaphragm electrode 123 in a circular shape, a rectangular shape, or a polygonal shape. At least a prescribed part of the diaphragm electrode 123 is positioned opposite to the fixed electrode 122 with a gap therebetween. That is, the fixed electrode 122 and the diaphragm electrode 123 form a pair of oppositely arranged electrodes forming a condenser. The support 124 has a multilayered structure including the substrate 12a, the lower insulating film 12b, the lower conductive film 12c, the spacer insulating film 12d, the upper conductive film 12e, and the surface insulating film 12f. The support 124 is formed to surround the fixed electrode 122 and the diaphragm electrode 123. The substrate 12a, the fixed electrode 122, and the diaphragm electrode 123 is are electrically connected to the impedance converter die 18 via electrodes (formed using thins films, not shown) running therethrough and bonding pads.

As described above, a part of the upper conductive film 12e forms the fixed electrode 122, while the other portion of the upper conductive film 12e forms the support 124. Due to such a mechanical structure, the periphery of the fixed electrode 122 is completely or partially connected to the support 124 so that the fixed electrode 122 is supported inside of the support 124. In addition, a part of the lower conductive film 12c is included in the diaphragm electrode 123, while the other portion of the lower conductive film 12c is included in the support 124. Due to such a mechanical structure, the periphery of the diaphragm electrode 123 is completely or partially connected to the support 124 so that the diaphragm electrode 123 is supported inside of the support 124.

When the electroacoustic transducer die 12 having the aforementioned structure shown in FIGS. 6A and 6B joins the plate 19 so that the fixed electrode 122 is positioned in the back cavity, the substrate 12a joins the plate 19 or the external wiring substrate 17 in an airtight manner via the adhesive. When the electroacoustic transducer die 12 joins the plate so that the fixed electrode 122 is positioned in the acoustic space, the surface insulating film 12f joins the plate 19 in an airtight manner via the adhesive.

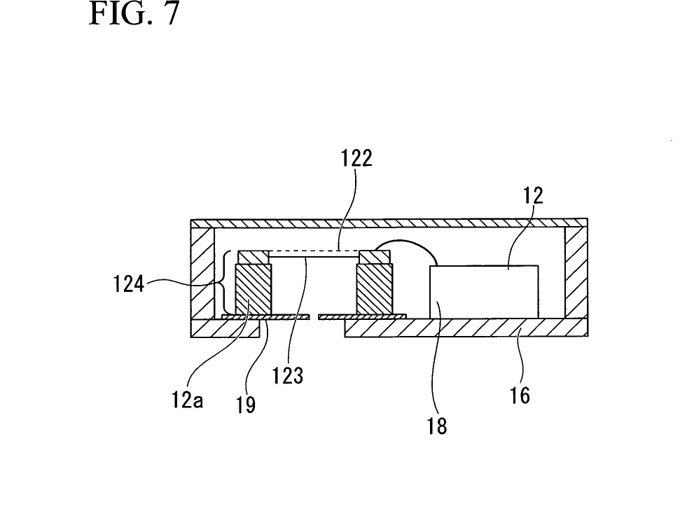

FIG. 7 shows the constitution of a condenser microphone including the electroacoustic transducer die 12 having the aforementioned structure shown in FIGS. 6A and 6B.

Conventionally, the back cavity is formed in connection with the substrate of the electroacoustic transducer die 12, wherein one end thereof communicates with a through-hole that is closed by the package. As the volume of the back cavity becomes large, it is possible to lower the cutoff frequency of the condenser microphone 1. It is not easy to form a through-hole in the substrate composed of a silicon wafer by way of etching. It may be necessary to form a through-hole running through the “thick” silicon wafer in order to secure a relatively deep volume of the back cavity. The present embodiment uses a redundant space inside of the package 16 as a part of the back cavity. Compared with the conventionally-known technology in which the back cavity is formed by way of etching, the present embodiment is advantageous in that the cutoff frequency can be increased to be higher. In addition, the present embodiment is not designed such that the back cavity is secured using only the internal space of the electroacoustic transducer die 12. Therefore, the present embodiment is capable of reducing the thickness of the condenser microphone 1 by simply reducing the thickness of the electroacoustic transducer die 12. Incidentally, it is possible to improve the sensitivity of the condenser microphone 1 by reducing the space between the plate 19 and the diaphragm electrode 123 and by increasing the surface area of the diaphragm electrode 123. In other words, it is preferable that the distance between the plate 19 and the diaphragm electrode 123 be reduced as small as possible, and the surface area of the diaphragm electrode 123 be increased as large as possible.

The fixed electrode 122 having the back through-holes 121 do not vibrate due to sound waves transmitted thereto via the acoustic space, while the diaphragm electrode 123 vibrates with respect to the fixed electrode 122. When the diaphragm electrode 123 receiving sound waves vibrates with respect to the fixed electrode 122, the capacitance formed between the fixed electrode 122 and the diaphragm electrode 123, which are positioned opposite to each other, varies so that the electroacoustic transducer die 12 converts sounds into electric signals.

### (3) Impedance Converter Die

The impedance converter die 18 includes a charge pump (not shown), which applies a bias voltage to one of the fixed electrode 122 and the diaphragm electrode 123, and an impedance converter (not shown), which is connected to the other of the fixed electrode 122 and the diaphragm electrode 123. The impedance converter converts a high-impedance output of the electroacoustic transducer die 12 into a low-impedance output, thus improving the noise resistance of the condenser microphone 1.

### (4) Package

The package 16 is constituted of a bottom portion 162, which is formed using a multilayered wiring substrate, and a cover 161, which forms a space (or a hollow cavity) inside of the package 16 together with the bottom portion 162.

The bottom portion 162 having a box-like shape excluding a cover is formed in a laminated structure including a conductive film (not shown), which forms wiring establishing connection between the impedance converter die 18 and the external wiring substrate 17, and a ceramic sheet (not shown). A through-hole 163, which overlaps and communicates with the second through-hole 17 formed in the external wiring substrate 17, is formed in the bottom portion 162 of the package 16. As shown in FIG. 1B, the through-hole 163 is positioned just below the electroacoustic transducer die 12, wherein it overlaps with the diaphragm electrode 123 via the plate 19 in plan view.

The cover 161 joins and completely covers the bottom portion 162 so as to prevent sound waves from unexpectedly entering into the package 16 via portions other than the through-hole 163 of the bottom portion 162 of the package 16. It is preferable that the cover 161 be formed using a conductor realizing a shield effect against noise. It is further preferable that the cover 161 be set to a ground potential.

### (5) Plate

The thickness of the plate 19 is smaller than the smaller of the thickness of the cover 161 and the thickness of the bottom portion 162 in the package 16; and as shown in FIG. 1B, the plate 19 has a periphery including a projection region F1 of the electroacoustic transducer die 12. The plate 19 is formed using a conductive film composed of a metal material, wherein it joins the bottom portion 162 of the package 16. As the material of the plate 19, it is possible to list stainless steel, beryllium copper, and a Fe—Ni alloy (or 64-alloy). Since the plate 19 directly joins the electroacoustic transducer die 12, it is preferable to select a material whose thermal expansion coefficient is close to the thermal expansion coefficient of the silicon wafer. In order to improve the shield effect against noise, it is preferable that the plate 19 be set to a ground potential.

A sound hole 191 is formed at a prescribed position of the plate 19. The sound hole 191 overlaps the through-hole 163 of the bottom portion 161 in plan view so as to communicate with the through-hole 163. There is a possibility in that dust, liquid drops, and light other than sound may enter into the sound hole 191. In order to avoid the propagation of dust, liquid drops, and light, it is preferable that the sectional area of the sound hole 191 be reduced as small as possible. The resonance frequency of the sound hole 191 decreases as the sectional area of the sound hole 191 decreases. In order to increase the resonance frequency to be higher than the audio frequency range, it may be preferable to increase the sectional area of the sound hole 191. In order to increase the resonance frequency of the sound hole 191, it is preferable that the depth of the sound hole 191 be reduced as small as possible. Since the depth of the sound hole 191 substantially matches the thickness of the plate 19, it is preferable that the thickness of the plate 19 be reduced as small as possible. The present embodiment is designed such that the depth of the sound hole 191 is reduced so as to increase the resonance frequency, and the sectional area of the sound hole 191 is reduced so as to avoid the propagation of dust, liquid drops, and light. Specifically, when the sound hole 191 has a circular sectional area, it is preferable that the diameter thereof be equal to or smaller than 100 μm, and the thickness of the plate 19 be equal to or smaller than 100 μm. The plate 19 having the sound hole 191 of a small depth can be produced by forming a film composed of a metal material on the surface of the bottom portion 162 of the package 16 by way of printing or application. As the plate 19 has a small thickness, it is easy to form a through-hole having a small sectional area. That is, it is possible to form the sound hole 191 of a small sectional area running through the plate 19 by way of etching using photolithography, laser beam machining, and press working, for example.

For experiments, the condenser microphone 1 of the present embodiment is actually produced in such a way that the diameter of the sound hole 191 is set to 100 μm, the depth of the sound hole 191 is set to 100 μm, the distance between the diaphragm electrode 123 and the plate 19 is set to 512 μm, and the diaphragm electrode 123 has a circular shape whose diameter is set to 700 μm. Through simulation, the resonance frequency of the condenser microphone 1 having the aforementioned dimensions is approximately 25 kHz, which is higher than the audio frequency range.

The present embodiment can be further modified in a variety of ways; hence, variations will be described below.

### B. First Variation

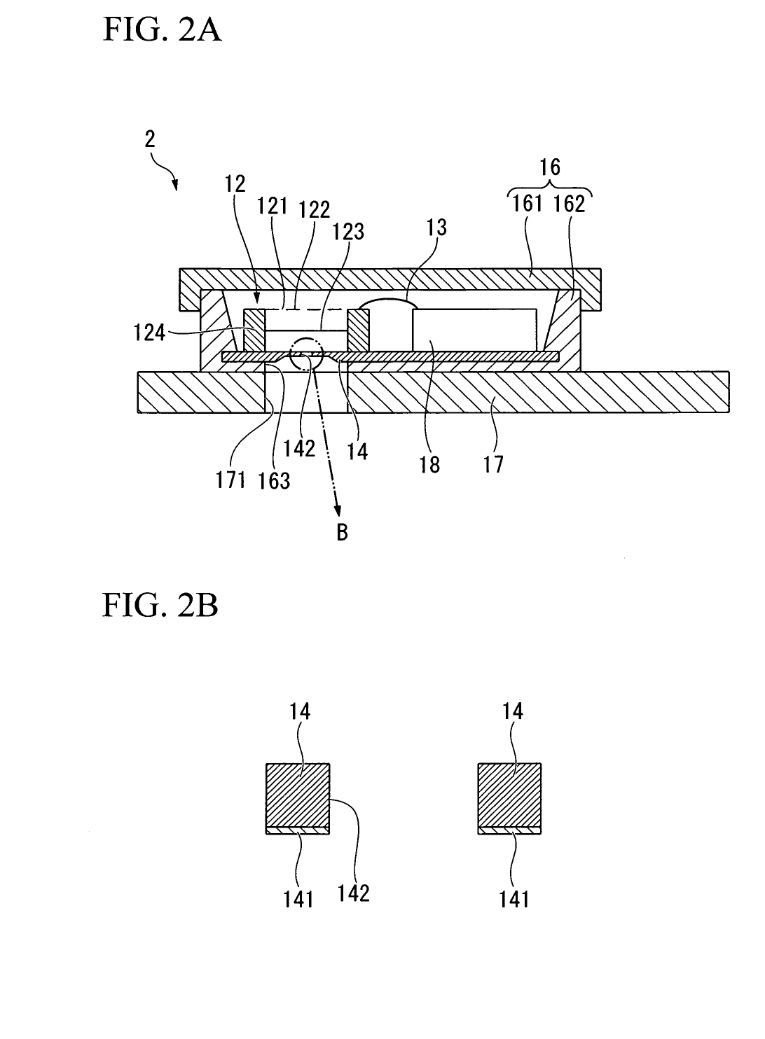

An electroacoustic transducer according to a first variation will be described with reference to FIGS. 2A and 2B. FIG. 2A is a longitudinal sectional view showing the essential parts of the electroacoustic transducer including a condenser microphone 2, wherein parts identical to those of the condenser microphone 1 are designated by the same reference numerals; hence, duplicate description thereof will be omitted. Compared with the condenser microphone 1, the condenser microphone 2 is characterized in that the bottom portion 162 of the package 16 forms a resin mold, in which a lead frame 14 sealed with a resin serves as the plate.

The condenser microphone 2 includes the lead frame 14, which forms an SOP (Small Outline Package), a QFP (Quad Flat Package), a PGA (Pin Grid Array) package, etc. The electroacoustic transducer die 12 and the impedance converter die 18 join the lead frame 14. A plurality of leads (not shown), which are connected to the impedance converter die 18 by way of wire bonding, are formed in the lead frame 14. The leads project externally from the bottom portion 162 forming the resin mold. The first variation is characterized in that the plate is formed using the lead frame 14 in order to form a sound hole 142 having a small sectional area and a small depth. This makes it possible to simplify the structure of the package and to reduce the manufacturing cost.

The prescribed portion of the lead frame 14 is not sealed with the resin mold and is reduced in thickness in comparison with the other portion of the lead frame 14, wherein the sound hole 142 is formed in the prescribed portion of the lead frame 14, the thickness of which is smaller than the smaller one of the thickness of the cover 161 and the thickness of the bottom portion 162 in the package 16. It is preferable that, as shown in FIG. 2B, a water-repellant film 141 be formed in proximity to the sound hole 142 on the prescribed surface of the lead frame 14 exposed externally from the package 16. The water-repellant film 141 is formed by coating the lead frame 14 with a water-repellant thin film composed of a silicon rubber or a fluorine-contained resin. Due to the formation of the water-repellant film 141 in proximity to the sound hole 142 exposed externally from the package 16, it is possible to reliably prevent liquid drops from unexpectedly entering into the package 16. It is preferable that the water-repellant film 141 be formed in at least the surrounding area of the sound hole 142 of the lead frame 14. It is preferable that the water-repellant film 141 be formed on both of the surface and backside of the lead frame 14 in the surrounding area of the sound hole 142. It is preferable that the water-repellant film 141 be formed on the interior wall of the sound hole 142.

### C. Second Variation

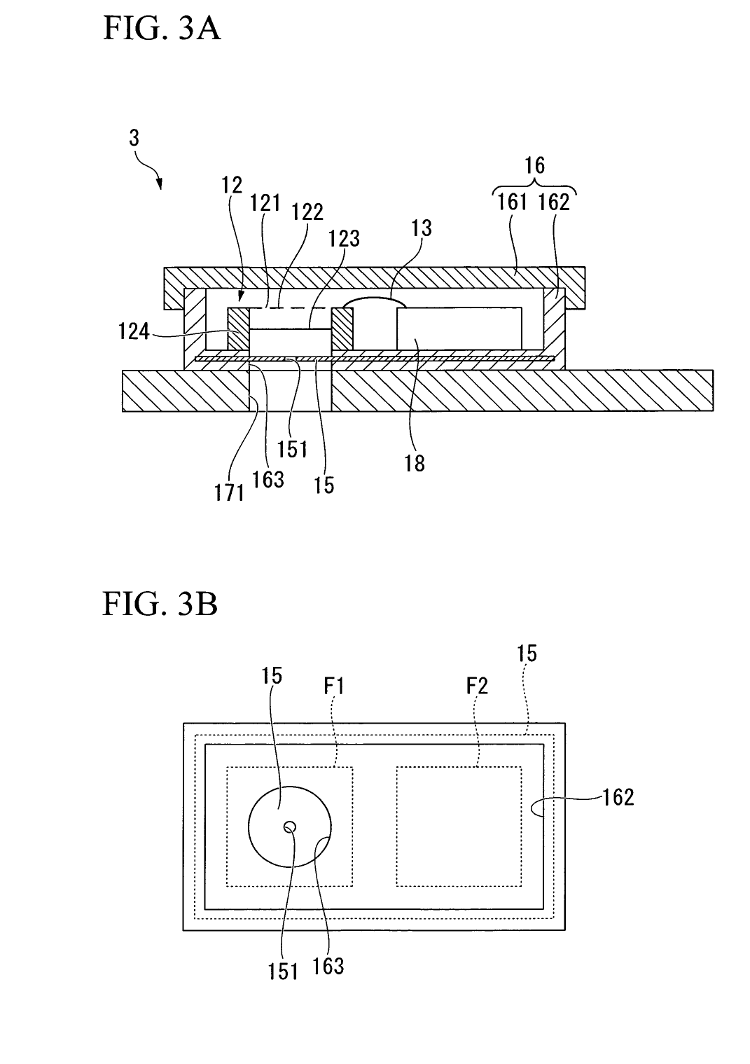

FIG. 3A is a longitudinal sectional view showing the essential parts of an electroacoustic transducer including a condenser microphone 3 in accordance with a second variation, wherein the parts identical to those shown in FIG. 1A are designated by the same reference numerals; hence, duplicate description thereof will be omitted. The electroacoustic transducer of FIG. 3A differs from the electroacoustic transducer of FIG. 1A in that a plate 15 is formed using a conductive film enclosed in the bottom portion 162 forming a multilayered wiring substrate.

The plate 15 serves as the conductive film, which is a part of the laminated structure of the multilayered wiring substrate. The thickness of the conductive film forming the plate 15 is smaller than both of the thickness of the cover 161 and the thickness of the bottom portion 162 in the package 16. A sound hole having a small sectional area and a small depth is formed to run through the plate 15 at a prescribed position. The periphery of the plate 15 includes the projection area F1 of the electroacoustic transducer die 12 and a projection area F2 of the impedance converter die 18 in plan view (see FIG. 3B). The plate 15 is set to a ground potential; therefore, the footprint of the package 16 substantially matches the footprint of the plate 15. For this reason, the condenser microphone 3 demonstrates a very high anti-noise shield effect, which is higher than the anti-noise shield effects of the condenser microphones 1 and 2.

A sample of the condenser microphone 3 is actually produced with prescribed dimensions in which the diameter of a sound hole 151 is set to 100 μm, the depth of the sound hole 151 is set to 100 μm, the distance between the diaphragm electrode 123 and the plate 15 is set to 512 μm, the distance between the surface of the bottom portion 162 and the surface of the plate 15 is set to 150 μm, and the diaphragm electrode 123 has a circular shape whose diameter is set to 700 μm. Through simulation, the resonance frequency of the condenser microphone 3 is approximately 22 kHz, which is higher than the audio frequency range.

### D. Third Variation

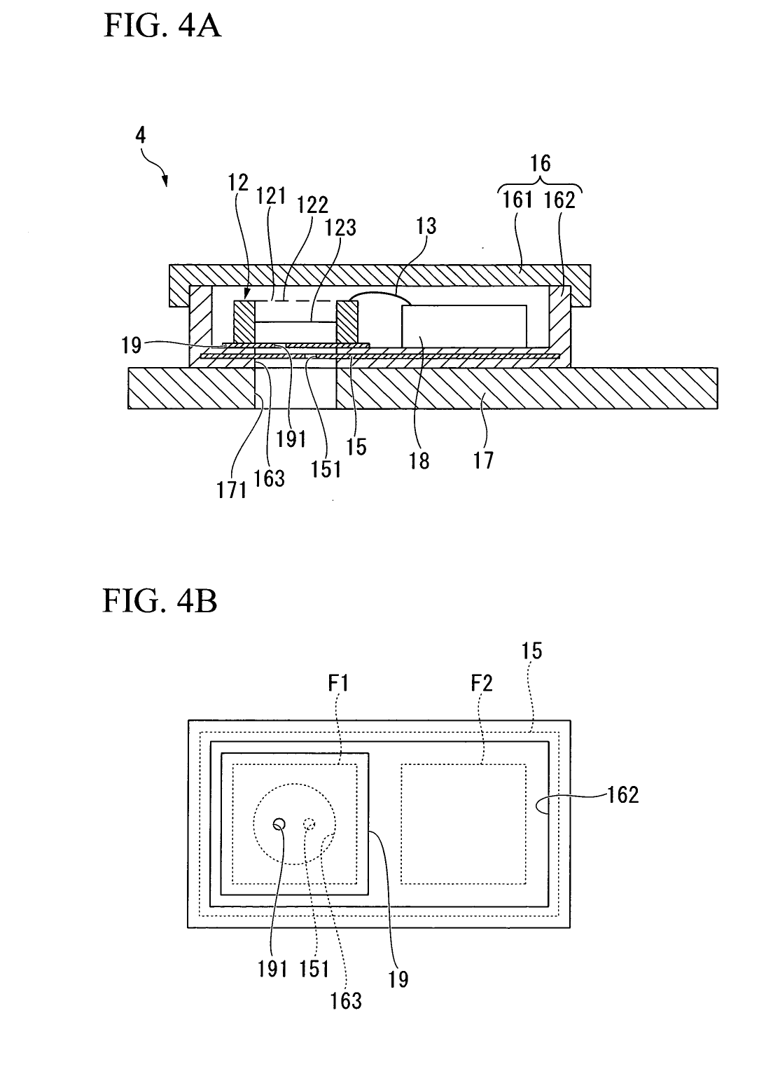

FIG. 4A is a longitudinal sectional view showing the essential parts of an electroacoustic transducer including a condenser microphone 4 in accordance with a third variation, wherein the parts identical to those shown in FIGS. 1A and 3A are designated by the same reference numerals; hence, duplicate description thereof will be omitted. Specifically, the condenser microphone 4 corresponds to a combination of the condenser microphones 1 and 3, in which there are arranged two plates, i.e., the first plate 19 that joins the surface of the bottom portion 162 forming the multilayered wiring substrate, and the second plate 15 that is formed using the conductive film forming a part of the laminated structure of the multilayered wiring substrate forming the bottom portion 162.

In the condenser microphone 4, both of the first plate 19 and the second plate 15 join an insulating layer of the multilayered wiring substrate, which is positioned therebetween. As shown in FIGS. 4A and 4B, the sound hole 191 of the first plate 19 and the sound hole 151 of the second plate 15 do not overlap with each other in plan view, but they are communicated with each other, thus allowing sound waves sequentially transmitted through the sound holes 151 and 191 to reach the diaphragm electrode 123. Since the sound holes 151 and 191 do not overlap with each other in plan view, it is very difficult for dust, light, and liquid drops to enter into the package 16 via the sound holes 151 and 191.

A sample of the condenser microphone 4 is actually produced with prescribed dimensions in which both of the sound holes 191 and 151 have the same diameter of 100 μm, both of the sound holes 191 and 151 have the same depth of 100 μm, the distance between the diaphragm electrode 123 and the first plate 19 is set to 512 μm, the distance between the first plate 19 and the second plate 15 is set to 150 μm, and the diaphragm electrode 123 has a circular shape whose diameter is set to 700 μm. Through simulation, the resonance frequency realized by the air gap between the first plate 19 and the second plate 15 is approximately 33 kHz, the resonance frequency realized by the air gap between the diaphragm electrode 123 and the first plate 19 is approximately 25 kHz, whereby the overall resonance frequency of the condenser microphone 4 is higher than the audio frequency range.

### E. Fourth Variation

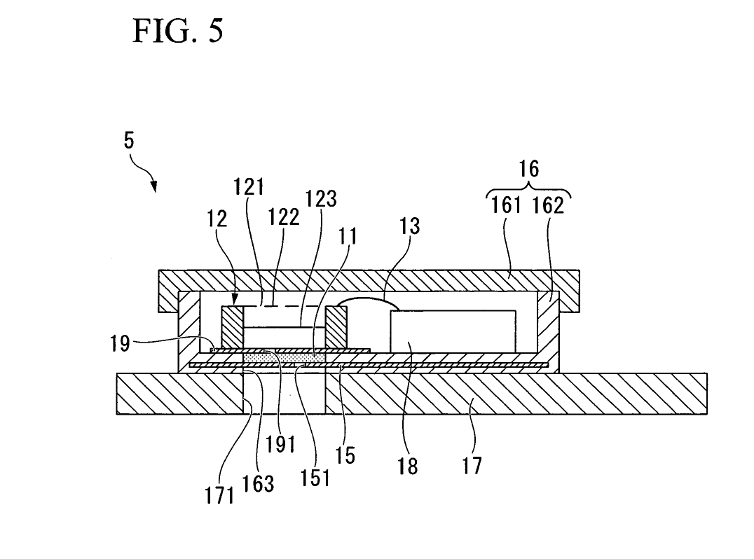

FIG. 5 is a longitudinal sectional view showing the essential parts of an electroacoustic transducer including a condenser microphone 5 in accordance with a fourth variation, wherein the parts identical to those shown in FIG. 4A are designated by the same reference numerals; hence, duplicate description thereof will be omitted. Compared with the condenser microphone 4, the condenser microphone 5 is characterized in that a porous sheet 11 is inserted between the first plate 19 and the second plate 15.

In plan view, the porous sheet 11 is held between the first plate 19 and the second plate 15 within the through-hole 163, which is formed in the bottom portion 162 forming the multilayered wiring substrate at a prescribed position. The porous sheet 11 is composed of a nonwoven fabric or a fabric material having air permeability and drip-proof property. Due to the provision of the porous sheet 11, it is possible for the condenser microphone 4 to reliably prevent dust, light, and liquid drops from entering into the package 16 via the sound holes 151 and 191.

Lastly, the present invention is not necessarily limited to the embodiment and its variations; hence, it is possible to realize further variations within the scope of the invention defined by the appended claims.

In general, as the number of sound holes formed in the plate becomes small, the resonance frequency becomes high. That is, the condenser microphone is not necessarily designed using one sheet of the plate having one sound hole; hence, it is possible to redesign the condenser microphone to have three or more sheets of plates, thus realizing three or more sound holes. The positioning of the sound hole can be appropriately determined; hence, the sound hole can be formed in the plate joining the cover of the package; alternatively, the sound hole can be formed in the plate joining the side wall of the package. The material of the plate, in which the sound hole has a small sectional area and a small depth, is not necessarily limited to the metal material; that is, the plate can be composed of other inorganic materials such as resins and ceramics. The present embodiment shows that the condenser microphone encapsulated in the package includes two dies, i.e., the electroacoustic transducer die and impedance converter die. Of course, it is possible to arrange a single die, which realizes the functions of both the electroacoustic transducer and impedance converter, and which is encapsulated in the package.

What is claimed is:

1. A condenser microphone comprising:
a package having a cavity and a through-hole;
a plate that joins the package and that has a sound hole communicated with the though-hole, wherein the plate is thinner than the length of the through-hole, and wherein the sound hole overlaps with the through-hole in plan view; and
an electroacoustic transducer die that is stored in the cavity of the package.

2. A condenser microphone according to claim 1, wherein the package comprises a bottom portion having the through-hole, which joins an external wiring substrate, and a cover, which joins the bottom portion so as to form the cavity together with the bottom portion, wherein the plate joining the bottom portion is smaller than the bottom portion in thickness, and wherein the electroacoustic transducer die includes a fixed electrode and a diaphragm electrode, which are positioned opposite to each other, as well as a support for supporting the fixed electrode and the diaphragm electrode, in which the support joins the bottom portion or the plate in a surrounding area of the sound hole.

3. A condenser microphone according to claim 1, wherein a depth of the sound hole is set to 100 μm or less, and a diameter of the sound hole is set to 100 μm or less.

4. A condenser microphone according to claim 1, wherein the plate is composed of a metal material.

5. A condenser microphone according to claim 1, wherein the plate forms a lead frame.

6. A condenser microphone according to claim 2, wherein the bottom portion forms a multilayered wiring substrate, and the plate is formed using a conductive film joining a surface of the multilayered wiring substrate.

7. A condenser microphone according to claim 2, wherein the bottom portion forms a multilayered wiring substrate, and the plate is formed using a conductive film embedded in the multilayered wiring substrate.

8. A condenser microphone comprising:
a package having a cavity and a through-hole;
a first plate and a second plate, which join the package, wherein a first sound hole of the first plate and a second sound hole of the second plate communicate with the though-hole and overlap with the through-hole in plan view; and
an electroacoustic transducer die that is stored in the cavity of the package, wherein the package comprises a bottom portion having the through-hole, which joins an external wiring substrate, and a cover, which joins the bottom portion so as to form the cavity together with the bottom portion, wherein each of the first plate and the second plate joining the bottom portion is thinner than the length of the through-hole, and wherein the electroacoustic transducer die includes a fixed electrode and a diaphragm electrode, which are positioned opposite to each other, as well as a support for supporting and enclosing the fixed electrode and the diaphragm electrode, in which the support joins the bottom portion or the plate in a surrounding area of the sound hole, and
wherein the first plate and the second plate, which join the bottom portion forming a multilayered wiring substrate, overlap with each other in plan view via an insulating layer therebetween.

9. A condenser microphone according to claim 8, wherein the first sound hole of the first plate does not overlap with the second sound hole of the second plate in plan view.

10. A condenser microphone according to claim 8, wherein a porous sheet is inserted between the first plate and the second plate.

11. A condenser microphone according to claim 1, wherein a water-repellant film is formed in a surrounding area of the sound hole in a backside of the plate positioned in proximity to the electroacoustic transducer die.

12. A condenser microphone according to claim 1, wherein a periphery of the plate includes a projection area of the electroacoustic transducer die.

13. A condenser microphone according to claim 1, wherein the plate is set to a ground potential.

14. An electroacoustic transducer comprising:
a condenser microphone; and
an external wiring substrate which the condenser microphone joins,
wherein the condenser microphone comprises
a bottom portion having a through-hole, which joins the external wiring substrate;
a cover that joins the bottom portion so as to form a cavity together with the bottom portion;
a plate, which joins the bottom portion and which is thinner than the length of the through-hole, wherein the plate has a sound hole overlapped with the through-hole in plan view; and
an electroacoustic transducer die including a fixed electrode and a diaphragm electrode, which are positioned opposite to each other, as well as a support for supporting the fixed electrode and the diaphragm electrode,
and wherein the external wiring substrate has a second through-hole that overlaps with the through-hole of the bottom portion.

15. An electroacoustic transducer according to claim 14, wherein the support joins the bottom portion or the plate in relation to a surrounding area of the sound hole of the plate.
